(19) United States
(12) Patent Application Publication
(10) Pub. No.: US 2017/0229727 A1
(43) Pub. Date: Aug. 10, 2017

(54) AN ENERGY CARRIER SYSTEM FOR A VEHICLE

(71) Applicant: VOLVO TRUCK CORPORATION, S-405 08 Göteborg (SE)

(72) Inventor: Staffan LUNDGREN, Hindäs (SE)

(73) Assignee: VOLVO TRUCK CORPORATION, S-405 08 Göteborg (SE)

(21) Appl. No.: 15/510,688

(22) PCT Filed: Sep. 12, 2014
(86) PCT No.: PCT/EP2014/002473

§ 371 Date: Mar. 12, 2017

(51) Int. Cl. H01M 8/18; H01M 8/1246; B60L 11/18; H01M 8/04082

(52) U.S. Cl. CPC H01M 8/184; H01M 8/04201; H01M 8/1246; B60L 11/18; H01M 2250/20; H01M 2008/1293

(57) ABSTRACT

A device and a method for providing electricity to an electric motor for propulsion of a vehicle are provided. The method comprises the features of feeding Energy Carriers (EC) in the shape of particles having a first oxidation state (I) from a first container on board the vehicle to an Solid Oxide Fuel Cell (SOFC). The EC are reacted at the SOFC to change the oxidation state from the first oxidation (I) to the second oxidation state (II) while producing electric energy. The EC is thereafter fed from the SOFC to a second container on board the vehicle. A reversed reaction is enabled on board the vehicle, e.g., by applying a voltage to the SOFC to reverse the reaction, and the EC are reacted to change its oxidation state from its second oxidation state (II) back to its first oxidation state (I) before the EC is returned to the first container. A system for performing the method is also provided.

### BACKGROUND AND SUMMARY

The invention relates to a fuel system for a land vehicle, e.g. trucks, buses, cars or construction equipment. The fuel system is directed to the use of metal powder or metal particles to be used as energy carriers in order to provide electrical power to vehicles.

There is a multitude of different fuel systems used today for land vehicles. The most commonly used fuel system today is probably liquid fuel systems based on a carbonaceous fuel, e.g. petrol or diesel. The fuel is used by an Internal Combustion Engine (ICE) in order to propel a vehicle. However, there is a desire to change from using fossil fuel to renewable energy sources in order to reduce the carbon dioxide emissions. One way of reducing the fossil fuel consumption is to replace the liquid fossil fuel for renewable fuels, e.g. methanol from fast growing energy woods may be used as a replacement fuel. Still another attempt to reduce the fossil fuel consumption is to use electric power systems in which an Electric Motor (EM) is used as an alternative or a complement to an ICE. A major drawback of electrical propulsion system is the ability to provide an energy storage which may provide enough energy for travelling a desired distance. In rough numbers, the energy density from liquid carbonaceous fuel such as petrol or diesel is of a magnitude at least 10 times higher than for an electric battery, i.e. the amount of useful energy per weight unit. Hence, there is a desire to provide an energy carrier which may have a higher energy density and may work efficiently in a land vehicle. One known fuel system which could be used is metal particles which by changing its oxidation state may release energy and produce electricity. An advantage with this fuel system is that it constitutes an energy carrier which has energy storage/density similar to the energy density of liquid HC fuel, such as gasoline or diesel. The energy storage capability is dependent on what type of metal powder is used, but it's for a number of metals possible to reach an energy storage density for 20-50 MJ/kg, if the full potential could be utilized. The other main merit with this system is that it is possible and plausible to have a relatively high total energy efficiency from charging electric energy to released electric energy of about 45% (about 67%*67% for charging and discharging the system). This is a lower efficiency in comparison with modern batteries that may have a corresponding efficiency of about 80%, but with the essential difference that the energy storage density metal powder is almost two orders of magnitude higher than compared with modern battery technology. A metal powder energy carrier system may thus open up for possibilities to produce a vehicle fuel system which uses electricity from a source having a substantially lower weight per energy unit than battery based systems.

One metal powder fuel system is for example disclosed in US 2006/99472 where metal particles are used as energy carriers. This system thus has the advantage of providing a high density energy carrier having an energy density in the same magnitude as for fossil liquid fuel. However, there is a problem in providing such a system for vehicles today which in an efficient way may be refueled and used on a daily basis for a reasonable cost. The present invention is directed to provide a system which may improve the cost efficiency and increase the usability of such a system to be based on a daily basis.

It is desirable to provide a device and method which makes the use of metal powder or metal blend matrix as a rechargeable energy carrier with the performance of a fuel in vehicles easier to handle. A fuel system according to an aspect of the present invention will enable onboard recharging, e.g. a “plug-in” electric propulsion system, with an operating range and a “comparable” fuel volume/weight similar to what diesel fuel provides today.

In a general perspective, an aspect of the invention is focusing on using metal-particles/matrix/surface in a reduced and oxidized state as the main energy carrier media, in combination with an electric energy converting system, e.g. a Solid Oxidizing Fuel Cell (SOFC) system, to enable charging and discharging of the energy carrier system. The metal atoms are reduced to be “charged” or filled and is “discharged” or used when oxidized.

The energy carrier system comprises a container system for storage of the metal “fuel” particles and a “fuel” feeding system for feeding the “fuel” to and from the charging and discharging system, e.g. a SOFC. There may of course be further optional devices included in the system, e.g. some heat energy recovery system making use of waste heat from the charging and discharging operations.

Hence, the invention is directed to a vehicle on board Energy Carrier System (ECS) comprising:
Energy carriers (EC) to be used as fuel. The EC are made of a rechargeable material, e.g. particles made partly or fully of metal, and being able to be oxidized and reduced, typically made of a metal suitable for this use
A container system for storage of the EC. The container system comprises a first container and a second container.
An Electric Energy Converter (EEC) being able to produce an electric current from oxidation and/or reduction of the EC.

A fuel feed system (112) which in a first discharge mode transport the EC 102, having a first oxidation state (I), from the first container to the second container via the EEC (113), whereby the oxidation state of the EC (102) is changed to a second oxidation state (II). The change of the oxidation state is due to an oxidation/reduction in the EEC so as to produce an electric current in the EEC before the EC reach the second container (104) for storage of particles in the second oxidation state (II).

The invention further includes the feature of designing the fuel feed system to also work in a second recharge mode. In this second recharge mode are the EC transported from the second container to the first container and the ECS is provided with charge function for changing the oxidation state of the EC from its second oxidation state (11) to its first oxidation state (I). The EC is thus regenerated to be used as fuel once more, a process comparable to the onboard recharging of a battery of an ordinary electric vehicle.

The Energy Carrier System (ECS) may be designed to use the Electric Energy Converter (EEC) also in the second recharge mode such that by applying a voltage to the EEC is the oxidation/reduction reaction reversed and the Energy Carriers (EC) regenerated.

The ECS could be constructed to comprise a mixing chamber in which a fuel exchange side of the EEC is present. The fuel exchange side is designed to oxidize and/or reduce the EC when they are in contact with the fuel exchange side. The EEC also comprises in this case a fluid exchange side, suitably located in a redox chamber, designed to reduce and/or oxidise a redox agent when in contact with the fluid exchange side. When the EC is in contact with the fuel exchange side and the redox agent is in contact with the fluid exchange side is a transport of an electric charge enabled through the EEC by the oxidation and reduction reactions at the respective sides of the EEC whereby electric energy is generated. The mixing chamber could be a fluidized bed and the Electric Energy Converter (EEC) could be a Solid Oxide Fuel Cell (SOFC).

The first and second containers could be placed besides each other, e.g. one (the first) container on top of the other one. In this case could they suitably be separated by a movable partition wall in order to be able to increase respective decrease the volumes of the respective containers as the volume need for the EC in the respective container change as the EC are transported to and from the containers.

In order to make use of waste heat produced in the oxidation/reduction reactions when the EC is used as fuel in the discharge mode, a first heat exchanger could be connected to the mixing chamber and the redox chamber in order to heat the flow of redox agent from the redox chamber 117 with the flow of EC from the mixing chamber. The heated flow of redox agent may be used for powering a turbine and/or for heating purposes. The turbine could be used to perform mechanical work for appropriate loads or to be connected to a generator for electricity production. Heat could be used to heat a driver's cabin or passenger compartment. In a specific embodiment could the heated flow of redox agent be used to power an expander turbine which forms part of a turbo compound system in which the expander turbine is mechanically connected to power a compressor turbine for pressurizing redox agent directed to an inlet in said redox chamber. However, the compressor could instead be powered electrically by for example electricity produced by a generator connected to the turbine. If there is still any heat comprised in the flow of the used redox agent from the expander turbine, it could be guided to a second heat exchanger for heating purposes, e.g. for preheating of fresh air to be directed to the redox chamber to be used as fresh redox agent.

The invention is also directed to a method for providing electricity to an electric motor for propulsion of a vehicle. The method comprises steps of
Feeding Energy Carriers (EC) in the shape of particles having a first oxidation state (I) from a first container onboard the vehicle to an Electric Energy Converter (EEC),
Reacting the EC at the EEC to change the oxidation state from the first oxidation (I) to the second oxidation state (II) while electric energy is produced in the EEC due to the change of the oxidation state of the EC,
Feeding EC from the EEC to a second container onboard the vehicle after they have been reacted to be in the second oxidation state.

The method also includes an on board regeneration of the Energy Carriers (EC) by feeding the EC from the second container to the first container whereby the EC (102) are reacted onboard the vehicle to change its oxidation state from its second (used) oxidation state (II) to its first (regenerated) oxidation state (I) such that the EC (102) may be returned to the first container to be used as fuel.

For this regeneration reaction could the EEC (113) be used by reversing the oxidation and reduction reaction by applying a voltage to the EEC in order to regenerate the EC. The change of the oxidation state of the EC from its second oxidation state (II) to its first oxidation state (I) is thus performed when the EC are guided via the EEC back from the second container (104) to the first container (103).

The process of discharging the metal particles, the “discharge” mode, and the energy conversion by oxidizing reduced metal particles to electric energy is described below:

A container system is used to contain metal particles. The metal particles are oxidized in the discharged state, i.e. after they have been used for producing electric energy for propulsion of the vehicle. When the metal particles of the energy carrier system are in a reduced state are they charged or “filled” and ready to be used as a fuel. Ideally, all particles should be able to be in the same state, i.e. to be reduced or oxidized, at the same time in order to be able to make use of the maximum possible capacity of the system. However, it may be hard to achieve a complete reduction/oxidation of all particles in practice. The metal particles used as energy carriers are preferably comprised in a closed system together with a suitable fluid, e.g. an inert gas. A suitable gas to be used is helium which has a good heat transfer capability. Alternatively, a suitable liquid could also be used. The reduced metal particles are transported by the fuel feeding system into a mixing chamber, e.g. a fluidized bed device, from a container dedicated to store reduced metal particles. In the mixing chamber is the fuel, i.e. the reduced metal particles, exposed to the “fuel” side of an electric energy converter, e.g. a Solid Oxide Fuel Cell (SOFC). The energy converter shall be suitably designed, e.g. as a cross flow type. The fuel is in this context the reduced metal particles that will be exposed to the surface of the electric energy converter (SOFC) by mixing chamber (the fluidized bed device) and thereby being oxidized to produce an electric current while also causing an exothermal heat release that increases the pressure and temperature. This waste heat could be used to power a turbine or the like arrangement for producing further electric energy or to be used for any suitable heat purpose, e.g. heating of the passenger compartment. In case a SOFC is used as electric energy converter could it be preheated at start up, e.g. by an electrical element, to reach a desired oxygen ion conducting temperature for the electrolyte of the SOFC. The SOFC could for example be a zirconium oxide type. On the outlet side of the mixing chamber, after the metal particles has passed by the electric energy converter, could a heat exchanger be located which the oxidized fuel (metal particles) passes through. The particles may thus to be cooled down before they are transferred in a cooled state to a container for used fuel (oxidized particles).

In an embodiment are the containers for charged fuel (reduced particles) and used fuel (oxidized particles) comprised within the same casing but divided by a movable partition wall. Such a storage arrangement is thus space saving since when the necessary space for storing oxidized particles is increasing (or decreasing) as they will be used as fuel (or to be recharged), there will be a need for a corresponding decrease (or increase) in the space for storing reduced particles used as fuel. In a storage arrangement wherein the used (oxidized) particles enter in a lower part of the storage arrangement, a transporter, e.g. a screw transporter, could be arranged to move the metal particles upwards in the lower container. A movable partition wall may thus move upwards to enlarge the space for the oxidized particles while a space above forming an upper container for the reduced particles will decrease to a corresponding extent. This motion could thus also function in order to feed the fluidized bed device with reduced particles from the container at the top of the storage arrangement and, as the partition wall moves slowly downwards, feeding oxidized particles to the increasing volume of the lower container volume. The particle outlet (inlet when the process is reversed) of the upper container should preferably be provided with some kind of valve, e.g. a back-pressure valve, preventing used particles in the mixing chamber from re-entering the upper container due to a temperature and pressure increase caused by the exothermal oxidation reaction heat release in the mixing chamber. The other side (the gas exchange side) of the electric energy converter, e.g. a SOFC, is connected to an oxidizing agent provider. The oxidizing agent may be any suitable fluid, e.g. an oxygen containing gas such as air or a liquid such as water. A suitable choice to be used for a vehicle is air since such an arrangement renders the need for an additional container for the oxidizing agent unnecessary. If necessary or desired, some purification or oxygen enriching arrangement may be used before the ambient air is introduced into the energy carrier system.

In the following is exemplified the use of air as an external supply of oxidizing agent to an oxidizing agent chamber comprising a gas exchange side of a SOFC and metal particles comprised in a helium atmosphere on the other (fuel) side of the SOFC. The air may be compressed by a compressor arranged to compress air to a pressure level of e.g. 2-5 bar or more before it's exposed to the entrance of the SOFC gas exchange side. The compression is made to minimize the needed surface area of the SOFC electrodes and thereby minimize the total needed volume for the desired power output from the energy carrier system and to contribute to the maintaining of the necessary operational temperature for the SOFC membrane. An oxygen enrichment of the air, e.g. by adding pure oxygen or removing other constituents (nitrogen) from the air, should also improve the effect. The metal particles in the mixing chamber on the fuel side of the SOFC are comprised in helium atmosphere at equal pressure, e.g. 2-5 bar. A pressure adjustment device might be needed to even out pressure difference between the two sides of the SOFC. This can be made by a membrane arrangement. The air exhausted from the oxidizing agent chamber, i.e. on the gas exchange side of the SOFC, may be used for the heat exchanger connected to the outlet from the mixing chamber, i.e. on the “fuel” side of the SOFC, such that the used fuel (oxidized particles) are cooled and the air exhausted from the oxidizing chamber is heated. The thereby increased temperature and pressure may be released by an expansion of the air through an expander unit comprising a turbine. The mechanical energy then generated by the expander may be used for powering the compressor (for compressing the air to be used in the oxidizing unit) and/or to power an electric generator when access energy can be recovered. The compressor and expander could be of different types, e.g. of a piston or turbo machinery type. Hence, it will be possible to generate electricity from the energy comprised in the waste air stream in addition to the output from the SOFC oxidizing process. A fractional part of this electric energy may be used to propel the metal particle screw device and fluidization of the particles in the fluidized bed. The current could of course be used for connection to any electric load and the major part of the electricity produced is of course intended to be used in an electric motor system for propulsion of a vehicle.

If the released exhausted air still contains residual heat after the expander-turbine arrangement it could for example be used in a passenger compartment Heating and Ventilation Air Condition (HVAC) unit.

The theoretical efficiency of a SOFC is about 67% and the heat release from the SOFC is known by “regular HC fuel” system to be large enough to run the gas exchange device and generate an additional electric power. A first assumption may be that the energy conversion from the SOFC could be possible to reach as the net efficiency of the SOFC. If so, the energy stored in the metal particle by their reduced state, is the released energy from this energy carrier device with a possible net efficiency of about 67%.

In order to recharge the metal particles to be used as fuel once more is the process in the energy carrier system essentially reversed, i.e. the state of the particles is changed from being oxidized to be reduced. Charging of the metal particles in the energy carrier device may be performed when desired or when all metal particles are converted to metal oxide particles (or essentially all particles are oxidized, there may be a small fraction which passes through the system without being oxidized). By reversing the oxidation ion transfer from the gas exchange side to the “fuel” side of the SOFC used in the oxidation mode (also called discharge mode) and thereby creating electricity, the process could be reversed by feeding the SOFC with an external current, e.g. by a “plug-in” system in which electricity from the grid or from any type of external electric energy recuperation device may be used. In this way may the oxidized metal particle be reduced again to assume their metal state by reversing the circulation of particles in the mixing chamber. Hence, the transporter will in this case be used to feed oxidized particles from the lower container to the mixing chamber where after the particles are fed to the upper container while the partition wall moves downward until all (or essentially all) particles are reduced and transferred to the upper container or the recharge process is stopped. Oxygen will be released from the metal oxide particle when exposed to the SOFC “fuel side” electrodes at elevated temperature and transported out of the container to the gas exchange side of the system by the externally connected electrical current. For both charging and discharging as described rate of energy released (the maximum power of this device) will be determined mainly by the relations of the particle feed, the transport efficiency of the fluidized bed and its mixing effect and the oxygen ion transport efficiency within the SOFC electrolyte.

The main merit is as described above the high primary energy density but also that the innovative solution has an efficiency that is relatively high, when put in relation to the energy density of the system. One other merit with above described invention is that the particles are contained in a closed, sealed off system for the metal particles and they need not to be removed to be generated or reduced. Hence, the risk of releasing small fractions of nano-particles into the environment when they are oxidized is reduced compared to the alternative method of feeding the metal particles into a normal combustion chamber of an engine for rapid oxidation. In for example a normal reciprocal engine is this a drawback as well as problems with lubrication and recapturing of particles from the exhaust flow etc.

### BRIEF DESCRIPTION OF THE DRAWINGS

With reference to the appended drawings, below follows a more detailed description of embodiments cited as examples of the invention.

In the drawings:

FIG. 1 is a schematic view of a vehicle provided with an Energy Carrier System (ECS) according to the invention, and,

FIG. 2 is a schematic view of the Energy Carrier System (ECS) shown in FIG. 1, and

FIG. 3 is a schematic view of a second embodiment of the ECS.

### DETAILED DESCRIPTION

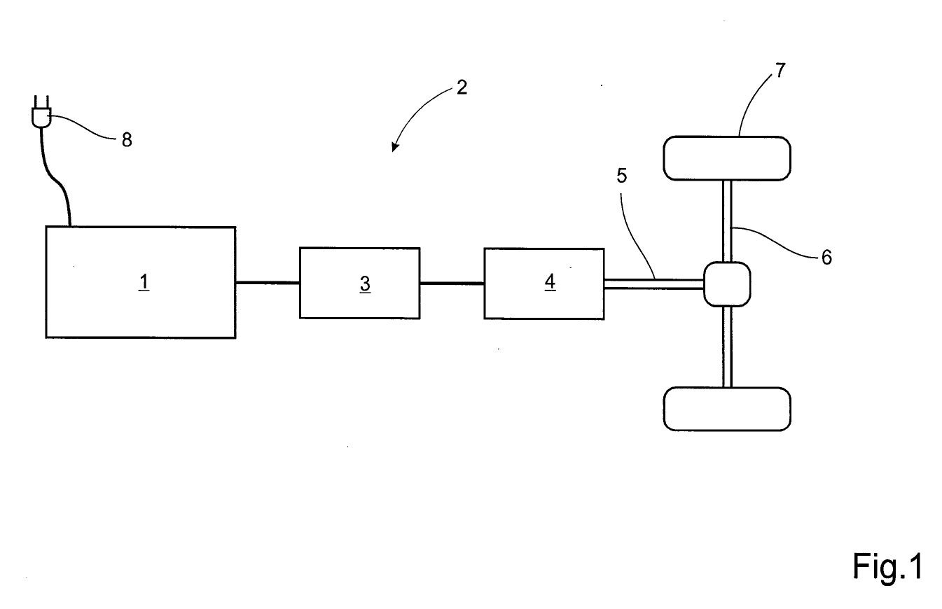

In FIG. 1 is disclosed a vehicle 2 provided with an Energy Carrier System (ECS) 1 according to the invention. The ECS 1 is designed to produce electric energy and is connected to an accumulator 3, e.g. a battery, for storage of the generated electrical energy. The accumulator 3 also comprises or is connected to Power Electronics Circuitry (PEC) for control of the electricity generating process (not shown). The accumulator 3 is connected to an Electric Motor (EM) 4 to be used as a propulsion unit for the vehicle. The EM 4 may be designed to work as a generator as well as a motor in order to be able to regenerate energy e.g. from braking of the vehicle 2. The EM 4 is further drivingly connected to a driven axle 6 comprising a pair of driven wheels 7 via a mechanical powertrain 5. Even though it is described the use of a driven axle 6 comprising a pair of driven wheels 7 could the electricity produced by the ECS 1 be used for any kind of electric propulsion system and the propulsion system described herein could for example be replaced with a system using a pair of wheel motors instead if desired. Hence, the ECS 1 could be used in any kind of electric propulsion system for vehicles. In order to recharge the ECS 1 it could be provided with a plug-in contact 8 such that it may be recharged by connecting it to the electrical grid. The ECS 1 system is primarily intended to be used in Electric Vehicles (EV) but could also be used Hybrid Electric Vehicles (HEV) in which the ECS is used together with an additional propulsion system, e.g. a mechanical powertrain powered by an Internal Combustion Engine (ICE). The reason why it is primarily intended for EV is that a purpose of the ECS is to be able to provide an improved range for an electrical propulsion system such that it shall not be needed to include an additional propulsion system.

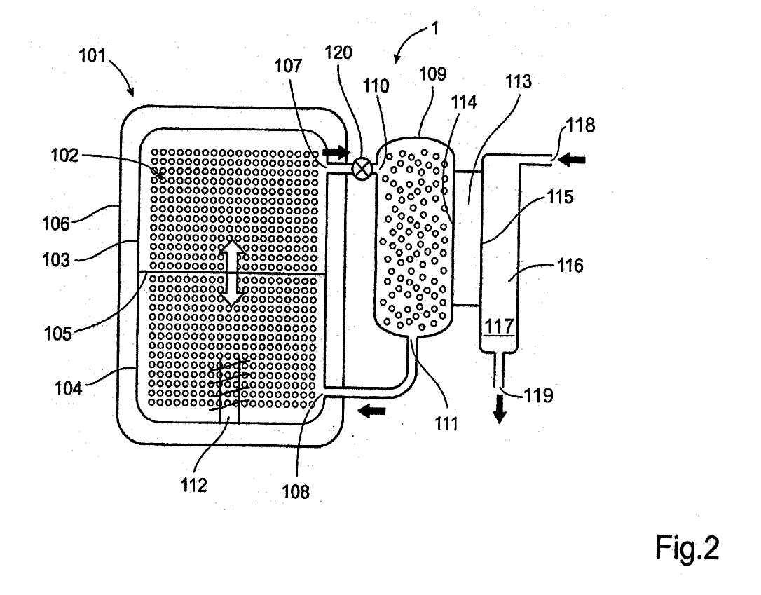

In FIG. 2 is disclosed a more detailed drawing of the Energy Carrier System (ECS) 1 disclosed. The ECS comprises a container system 101 for storage of metal particles to be used as energy carriers 102 in the ECS. The container system 101 includes an upper container 103 for storage of reduced particles placed on top of a lower container 104 for oxidized particles. The upper and lower container 103, 104 are divided by a movable partition wall 105 which may move up and down in order to decrease respective increase the volume of the upper and lower container by moving up or down. The upper and lower container 103, 104 are comprised in a common casing 106 and are connected to each other via a mixing chamber 109. The mixing chamber 109 is in this embodiment exemplified by a fluidized bed. The upper container 103 is thus provided with a fuel feed outlet 107 connected to a mixing chamber fuel inlet 110 and the lower container 104 is provided with a fuel return inlet 108 connected to a mixing chamber fuel outlet 111. The energy carriers 102 may thus be transported from the upper container 103 to the lower container 104 via the mixing chamber when the ECS 1 is used as an energy source for powering a vehicle. The ECS 1 is further provided with some kind of particle transporter or fuel feed system 112, which in this embodiment is exemplified by a screw transporter located in the lower container 104, in order to enable the flow of the energy carriers through the system. The ECS 1 may also be provided with some kind of motor arrangement for controlling the up- and downwards movement of the movable partition wall 105 as the quantity of energy carriers change in the upper and lower containers 103, 104 during discharge and charge mode. The ECS is further provided with an Electric Energy Converter (EEC) 113 which is exemplified by a Solid Oxide Fuel Cell (SOFC). The EEC 113 has a fuel exchange side 114 which is designed to be in contact with the energy carriers 102 in the mixing chamber 109 and a redox side 115 which is designed to be in contact with an reducing/oxidation (redox) agent 116 in a redox chamber 117. The redox chamber 117 is provided with an inlet 118 and an outlet 119 for circulation of a redox agent 116. The redox agent 116, i.e. an agent which may be used for reduction and oxidation of the energy carriers 102 used as fuel, may for example be air taken from the surrounding environment. Before entering the redox chamber the air may be pre-treated, e.g. purified by filters, pressurized and/or heated.

The system is also provided with valves at suitable locations for control of the respective flows. In FIG. 2 is disclosed a fuel feed valve arrangement 120 in the conduit between the fuel feed outlet 107 and mixing chamber fuel inlet 110. The fuel feed valve arrangement 120 may thus be used to control the flow of metal particles 102 between the upper container 103, comprising reduced metal particles, and the mixing chamber 109. The fuel feed valve arrangement 120 may be a two stage valve arrangement so as to function as a feeder, e.g. by stepwise feeding, of metal particles and as a non-return valve, e.g. a back-pressure valve, when the ECS 1 is used in its discharge mode, i.e. when reduced metal particles are fed from the upper container 103 to the mixing chamber 109 to be oxidized and used as fuel in the SOFC 113. The valve arrangement 120 is preventing used fuel (i.e. discharged/oxidized particles) to re-enter the upper container 103 due to a heat and pressure increase from the exothermal oxidation process of the reduced energy carriers (metal particles) 102 at the fuel exchange side 114 of the EEC (SOFC) 113 in the mixing chamber (fluidized bed) 109. There is only one valve arrangement disclosed in FIG. 2. However, it is considered that the ECS 1 may be provided with further valves or flow control or guiding elements in order to control and direct the flow of the energy carriers (metal particles) 102 between the storage containers 103, 104 and to and from the fluidized bed 109. There may also be flow guiding means provided in the fluidized bed, e.g. flanges which serve to direct the particles entering the fluidized bed 109 towards the SOFC 113 for oxidation or reduction and or to improve the mixing and avoid stagnant zones. There could also be active flow directors e.g. some kind of ejector or nozzle arrangement in the fuel feed respectively return conduits 107, 108 to aid the particles 102 entering the mixing chamber 109. In a similar manner, some kind of suction arrangement could be used to make the metal particles return to the desired container. For example, if the pressure in the fluidized bed 109 is set at a medium pressure, the pressure of the container wherefrom the particles shall be discharged into the container may be set above the mixing chamber pressure and the container to which particles are transported from the fluidized bed may be set below the medium pressure of the fluidized bed. Hence, there may be further features in ECS 1 in addition to, or to replace, the transport screw.

As described above, one container is located on top of the other one. However, the containers could be placed beside each other while you still may use the beneficial arrangement of having a moving partition wall in order to decrease the total space dedicated for the container system 101 since the container space for the two containers decreases respectively increases as the particle amount in the respective container decreases respectively increases as particles are circulated to be oxidized or reduced in the ECS. However, if there is no need or desire to design a space saving container system for the metal particles, the containers may be located at any appropriate location, e.g. there may be separate containers, without a common casing, if the need for a space saving solution not is necessary.

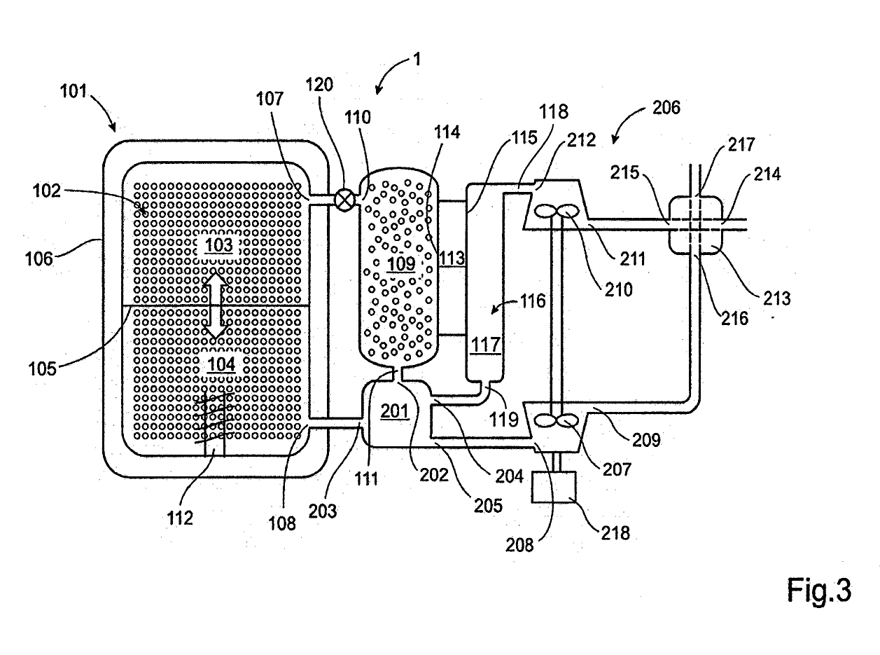

In FIG. 3 is disclosed second embodiment of the invention in which the ECS 1 has been provided with an arrangement for making use of thermal energy produced by the energy carriers 102 in the oxidation process at the fuel exchange side 114 of the EEC 113. The ECS 1 has been provided with a first heat exchanger (HX1) 201. The heat exchanger is provided with a fuel inlet 202, connected to the mixing chamber fuel outlet 111, and a fuel outlet 203, connected to the fuel return inlet 108 in the lower container 104 for circulating of energy carriers 102 through the HX1 201 to be used as a heat source. The HX1 201 is further provided with a redox inlet 204, connected to the redox chamber outlet 119, and a redox outlet 205, connected to the inlet 208 of an expander turbine 207. The HX1 201 is thus used for transferring heat in the flow of energy carriers 102, which when being oxidized in the discharge mode are heated, to the flow of the redox agent 116, e.g. air, which after being heated in the HX1 201 may be used as a power source for a turbo compound system 206.

In the discharge mode, the flow of the redox agent (air) 116 being heated in the HX1 201 is guided to the expander inlet 208 in order to power the expander turbine 207. The expander turbine 207 forms part of the turbo compound system 206 and is connected to and designed to power a compressor turbine 210. The compressor turbine 210 is in this example designed to compress fresh air 116, which enters through a compressor inlet 211, to a desired pressure by the compressor turbine 210. The compressed air is further guided through a compressor outlet 212 to the redox chamber 117 via inlet 118 where after the redox agent 116 may be reduced at the surface of the fluid exchange side 115 of the EEC (SOFC) 113 and thus provide oxygen ions to be transported through the EEC 113 to the fuel exchange side 114 and be used as oxidizing agent for the energy carriers 102 in the mixing chamber 109.

The ECS 1 has further been provided with a second heat exchanger (HX2) 213 which is provided with a fresh air inlet 214 and an air outlet 215, connected to the inlet 211 to the compressor turbine 210, in order to provide fresh air to be used as redox agent 116 in the ECS 1. This flow of fresh air is heated in the second heat exchanger (HX2) 213 by a flow of used (hot) redox agent 116 from the expander outlet 209 which enters through a redox inlet 216 and is discharged through a redox outlet 217. If there still is some usable heat left in the flow of used redox agent 116 after passing through HX2 213, this heat may be used for other heating purposes, e.g. for heating of a cabin.

The turbo compound system 206 may be connected to a generator 218 which may be used for production of electric energy if there is an excess of energy after using the expander turbine 207 to power the compressor turbine 210.

The system described for making use of waste heat from the ECS 1 in FIG. 3 may be modified to include more or less components. For example, the second heat exchanger 213 needs not to be included in the system. Similarly, the expander turbine 207 need not be connected to both a generator 218 and a compressor turbine 210 but could be connected to only one of these devices. For example, the expander turbine could be connected only to the generator 218 such that all the energy produced in the expander turbine 207 is used to generate electricity and, if desired to use a compressor unit, this could be electrically powered.

It is to be understood that the present invention is not limited to the embodiments described above and illustrated in the drawings; rather, the skilled person will recognize that many changes and modifications may be made within the scope of the appended claims.

1. An Energy Carrier System (ECS) for a vehicle comprising:
Energy carriers (EC) to be used as fuel, the EC being in the shape of particles and being able to be oxidized and reduced,
A container system for storage of the EC, the container system comprising a first container and a second container,
A Solid Oxide Fuel Cell (SOFC) being able to produce an electric current from oxidation and/or reduction of the EC,
A fuel feed system which in a first discharge mode transports the EC, having a first oxidation state, from the first container to the second container via the Solid Oxide Fuel Cell (SOFC), whereby the oxidation state of the EC is changed to a second oxidation state by an oxidation/reduction in the Solid Oxide Fuel Cell (SOFC) so as to produce an electric current in the Solid Oxide Fuel Cell (SOFC) before the EC reaches the second container for storage of particles in the second oxidation state
wherein
the fuel feed system in a second recharge mode transports the EC from the second container to the first container wherein the ECS is provided with charge function for changing the oxidation state of the EC from its second oxidation state to its first oxidation state.

2. An Energy Carrier System (ECS) according to claim 1 wherein the Solid Oxide Fuel Cell (SOFC) is used also in the second recharge mode such that by applying a voltage to the Solid Oxide Fuel Cell (SOFC) is the oxidation/reduction reaction reversed.

3. An Energy Carrier System (ECS) according to claim 1, wherein the system comprises a mixing chamber comprising a fuel exchange side of the Solid Oxide Fuel Cell (SOFC) which is designed to oxidise and/or reduce the Energy Carriers (EC) when in contact with the fuel exchange side and the Solid Oxide Fuel Cell (SOFC) further comprising a fluid exchange side, located in a redox chamber, designed to reduce and/or oxidise a redox agent when in contact with the fluid exchange side in such a way that a transport of an electric charge is enabled through the Solid Oxide Fuel Cell (SOFC) by the oxidation respectively reduction reactions at the fuel exchange side respectively the fluid exchange side, whereby electric energy is generated.

4. An Energy Carrier System (ECS) according to claim 3, wherein the mixing chamber is a fluidized bed.

5. (canceled)

6. An Energy Carrier System (ECS) according to claim 1, wherein the first and second containers are placed besides each other and are separated by a movable partition wall in order to be able to increase respective decrease the volumes of the respective containers as the volume need for the Energy Carriers (EC) in the respective container change as the EC are transported to and from the containers.

7. An Energy Carrier System (ECS) according to claim 3, wherein a first beat exchanger is connected to the mixing chamber and the redox chamber in order to heat the flow of redox agent from the redox chamber with the flow of Energy Carriers (EC) from the mixing chamber whereby the heated flow of redox agent may be used for powering an expander turbine and/or for heating purposes.

8. An Energy Carrier System (ECS) according to claim 7, wherein the heated flow of redox agent is used to power an expander turbine which forms part of a turbo compound system in which the expander turbine is mechanically connected to power a compressor turbine for pressurizing redox agent directed to an inlet in the redox chamber.

9. An Energy Carrier System (ECS) according to claim 7, wherein the expander turbine is connected to a generator for production of electricity.

10. An Energy Carrier System (ECS) according to claim 7, wherein the flow of the used redox agent from the expander turbine is guided to a second heat exchanger for heating purposes, e.g. for preheating of fresh air to be directed to the redox chamber to be used as fresh redox agent.

11. An Energy Carrier System (ECS) according to claim 1, wherein the Energy Carriers (EC) are circulated in a closed pressurized system, preferably having a pressure of 2 to 5 bar.

12. A vehicle comprising the Energy Carrier System according to claim 1.

13. A method for providing electricity to an electric motor for propulsion of a vehicle, the method comprising:
Feeding Energy Carriers (EC) in the shape of particles having a first oxidation state from a first container onboard the vehicle to a Solid Oxide Fuel Cell (SOFC),
Reacting the EC at the Solid Oxide Fuel Cell (SOFC) to change the oxidation state from the first oxidation to the second oxidation state while electric energy is produced in the SOFC due to the change of the oxidation state of the EC,
Feeding EC from the Solid Oxide Fuel Cell (SOFC) to a second container onboard the vehicle after they have been reacted to be in the second oxidation state
feeding the EC back on board the vehicle from the second container to the first container; and
reacting the EC onboard the vehicle to change its oxidation state from its second oxidation state to its first oxidation state before returning the EC is to the first container.

14. A method according to claim 12, comprising using the SOFC for the reaction of changing the oxidation state of the EC from its second oxidation state to its first oxidation state and feeding the EC from the second container to the first container via the Solid Oxide Fuel Cell (SOFC) which reverse the oxidation reaction by applying a voltage to the the Solid Oxide Fuel Cell (SOFC).
